(19) United States
(12) Patent Application Publication
(10) Pub. No.: US 2026/0332975 A1
(43) Pub. Date: Oct. 22, 2026

(54) DETECTING OUTLIERS IN A HEAD-RELATED FILTER SET

(71) Applicant: Telefonaktiebolaget LM Ericsson (publ), Stockholm (SE)

(72) Inventors: Mengqiu ZHANG, Stockholm (SE); Erlendur KARLSSON, Stockholm (SE); Tomas JANSSON TOFTGÅRD, Stockholm (SE)

(73) Assignee: Telefonaktiebolaget LM Ericsson (publ), Stockholm (SE)

(21) Appl. No.: 19/130,773

(22) PCT Filed: Nov. 18, 2022
(86) PCT No.: PCT/EP2022/082390

§ 371 Date: May 16, 2025

(51) Int. Cl. H04S 7/00

(52) U.S. Cl. CPC H04S 7/30; H04S 2420/01

(57) ABSTRACT

A method is provided. The method comprises obtaining head-related, HR, filter data indicating a set of HR filters for generating audio corresponding to temporal and/or spectral changes of sound waves, determining a time interval for evaluating HR filters included in the set, and evaluating at least one HR filter included in the set using the determined time interval. Audio is generated based on the evaluation.

### TECHNICAL FIELD

This disclosure relates to detecting outliers in a head-related (HR) filter set.

### BACKGROUND

The human auditory system is equipped with two ears that capture the sound waves propagating towards the listener. FIG. 4 illustrates a sound wave propagating towards a listener from a direction of arrival (DoA) specified by a pair of elevation and azimuth angles in the spherical coordinate system. On the propagation path towards us each sound wave interacts with our upper torso, head, outer ears, and the surrounding matter before reaching our left and right ear drums. This interaction results in temporal and spectral changes of the waveforms reaching the left and right eardrums, some of which are DoA dependent. Our auditory system has learned to interpret these changes to infer various spatial characteristics of the sound wave itself as well as the acoustic environment in which the listener finds himself/herself. This capability is called spatial hearing, which concerns how spatial cues are evaluated embedded in the binaural signal, i.e., the sound signals in the right and the left ear canals, to infer the location of an auditory event elicited by a sound event (a physical sound source) and acoustic characteristics caused by the physical environment (e.g., small room, tiled bathroom, auditorium, cave, etc.). This human capability, spatial hearing, can in turn be exploited to create a spatial audio scene by reintroducing the spatial cues in the binaural signal that would lead to a spatial perception of a sound.

The main spatial cues include 1) angular-related cues: binaural cues, i.e., the interaural level difference (ILD) and the interaural time difference (ITD), and monaural (or spectral) cues; 2) distance-related cues: intensity and direct-to-reverberant (D/R) energy ratio. A mathematical representation of the short time DoA dependent temporal and spectral changes (1-5 msec) of the waveform are the so-called head-related (HR) filters. The frequency domain (FD) representations of those filters are the so-called head-related transfer functions (HRTFs), and the time domain (TD) representations are the head-related impulse responses (HRIRs). FIGS. 17A-E illustrates an example of ITD and spectral cues of a sound wave propagating towards a listener. The four plots illustrate the time domain and the frequency domain responses of a pair of HR filters obtained at an elevation of 0 degrees and an azimuth of 40 degrees (The data is from CIPIC database: subject-ID 28. The database is publicly available and can be access from the link https://www.ece.ucdavis.edu/cipic/spatial-sound/hrtf-data/.).

HR filters are often estimated from acoustic measurements as the impulse response of a linear dynamic system that transforms the original sound signal (input signal) into the left and right ear signals (output signals) that can be measured inside the ear channels of a listening subject at a predefined set of elevation and azimuth angles on a spherical surface of constant radius from a listening subject (e.g., an artificial head, a manikin or human subjects). FIG. 18 sketches a simplified setup for HR filter binaural recording. Such acoustic measurement requires an acoustically well-treated environment (e.g., an anechoic chamber), a set of dedicated audio playback and acquisition equipment (e.g., loudspeakers, in-ear microphones, an amplifier, a soundcard, etc.), a source/listener positioning system, and a dedicated software package for playing, acquiring, and processing audio data.

The estimated (either by measurement or by numerical simulation) HR filters are often provided as Finite Impulse Response (FIR) filters. These FIR filters are usually several milliseconds long, where the temporal span of each filter can be divided into the three sequential temporal regions, i.e., the pre-active-region, the active-region, and the post-active-region. In the pre- and the post-active-regions the filter taps are zero or due to estimation noise very close to zero and contribute very little to the binauralization. The active-region contains the main parts of the impulse response of the filter that stand for actual binauralization. In the beginning of the active-region there are typically strong oscillations around zero which taper off and decrease to close-to-zero values in the end of the region. In the plots of the time domain responses in FIGS. 17A-17B, the active-region is roughly indicated by a dashed circle.

HR filter sets may be used:
directly in their original form by a binaural audio renderer, where a spatial audio is rendered by filtering an audio source signal with a pair of HR filters of a desired location, or
for predictive modeling, where the resulting model is used to provide HR filters for a spatial audio renderer.

The spatial quality of a rendered spatial audio is largely determined by the HR filter set used in the binaural renderer. Considerable effort has been put into improving acoustic measurements in order to obtain high-quality HR filter sets. However, variability is an inherent part of the HR filter measurement where noise or measurement errors are inevitable.

In the acoustic HR filter measurement, especially with human subjects, a special chair is usually designed to have a structure with head rest and back rest that provides a reference position of the subject's head relative to the loudspeaker(s) with the aim to minimize undesired head movements during measurements. However, a slight tilt of a subject's head or a slight tilt of the chair's vertical axis of rotation often occurs and causes misalignment of the positions between loudspeaker(s) and head. Such misalignment results in offset of the time of arrival (TOA) of the signal at the eardrum, or in other words, the onset delay of the HR filter. The offset of onset delay implies discontinuity of ITD between neighboring measurement points. For example, the ITDs of the HR filters at azimuth 0 degrees are supposed to be 0. When misalignment occurs, the ITDs deviate from 0. For an audio scene with a source moving along a vertical line in front of the listener, instabilities (left/right wobbling) can be perceived for the renderer using the HR filters with this misalignment error even for a deviation as small as ±1 sample (e.g., 0.02 msec at 48 kHz sample rate). An effective modeling-based method for correcting such misalignment errors in the HR filters is discussed in WO 2022/223132.

Non-HR reflection from the mechanical setup is another source causing errors in the HR filter measurement. The mechanical setup is always carefully designed to have a minimal effect on incident acoustic waves, e.g., the sides of loudspeakers are wrapped in acoustic absorbers, the supporting structure of the chair is covered by acoustic absorbers, and so on. However, non-HR reflections may still occur and can be captured in the recording. Such non-HR impulse responses appear in the resulting HR filter, which may destroy the ILD cue at certain frequency bands resulting in a perceivable “auxiliary” source somewhere other than the desired location. This type of error can be largely mitigated by a linear regression approach, as discussed in WO 2021/074294.

### SUMMARY

In addition to the above-mentioned two types of errors, an HR filter set may also contain outlier HR filters (a.k.a., “outliers”), which deviate significantly from an overall pattern of HR filters and, some may not contain spatial cues for localization at all.

Outliers in an HR filter set arise due to different reasons such as mechanical issues of the measurement setup and fault activities during the acoustic measurements. Outliers appear probably even more prominently when an HR filter set is obtained using low-cost equipment, e.g., in a home environment.

Using an HR filter set containing such outliers may result in extreme poor spatial localization of an audio source or cause other audible degradations in the spatial audio rendering. If such outliers exist in an HR filter set, and such HR filter set is used by a spatial audio renderer, the resulting binaural output will not be as intended. Also, if such HR filter set is used to train a predictive model, the outliers would yield an incorrect predictive model which generates flawed filters. Therefore, there is a need to detect such outliers and remove them before an HR filter set is used by a spatial audio renderer or is provided to a modeling algorithm to learn on.

Accordingly, the embodiments of this disclosure provide an outlier detection framework for detecting outliers in an HR filter dataset.

Thus, in one aspect of the embodiments of this disclosure, a method is provided. The method comprises obtaining head-related, HR, filter data indicating a set of HR filters for generating audio corresponding to temporal and/or spectral changes of sound waves. The method further comprises determining a time interval for evaluating HR filters included in the set; and evaluating at least one HR filter included in the set using the determined time interval. Audio is generated based on the evaluation.

In another aspect, there is provided a computer program comprising instructions which when executed by processing circuitry cause the processing circuitry to perform the method of any one of the embodiments described above.

In another aspect, there is provided a carrier containing the computer program of any one of the above embodiments, wherein the carrier is one of an electronic signal, an optical signal, a radio signal, and a computer readable storage medium.

In another aspect, there is provided an apparatus. The apparatus is configured to obtain head-related, HR, filter data indicating a set of HR filters for generating audio corresponding to temporal and/or spectral changes of sound waves. The apparatus is further configured to determine a time interval for evaluating HR filters included in the set; and evaluate at least one HR filter included in the set using the determined time interval. Audio is generated based on the evaluation.

In another aspect, there is provided an apparatus. The apparatus comprises a memory and processing circuitry coupled to the memory, wherein the apparatus is configured to performed the method of any one of the above embodiments.

Some of the embodiments of this disclosure allow detecting outliers in an HR filter dataset without requiring a clean dataset for training. Also, the outlier detection method according to some embodiments work for datasets containing only normal data or containing both normal data and outliers. Lastly, the outlier detection method according to some embodiments is insensitive to data variations, e.g., the spatial-temporal variation, individual variation among different subjects, and measurement-related variation among different measurement systems.

### BRIEF DESCRIPTION OF THE DRAWINGS

The accompanying drawings, which are incorporated herein and form part of the specification, illustrate various embodiments.

FIG. 1 shows a system according to some embodiments.

FIGS. 2A, 2B, 3A, and 3B illustrate concept of an HR filter.

FIG. 4 shows a propagation vector indicating a propagation direction of an audio wave within a three-dimensional (3D) space.

FIG. 5 shows a set of head-related filters located on a 3D sphere.

FIG. 6 shows an apparatus according to some embodiments.

FIGS. 7A, 7B and 7C shows exemplary responses of HR filters.

FIG. 8 shows a Spatial Index of Dispersion (SIOD) curve.

FIG. 9A shows an SIOD curve.

FIG. 9B shows an SIOD curve.

FIG. 10A shows a Temporal Index of Dispersion (TIOD) curve.

FIG. 10B shows a TIOD curve.

FIG. 11 shows a process according to some embodiments.

FIG. 12 illustrates a method of determining an initial start point.

FIG. 13 shows an example of frequency density of peak locations.

FIG. 14 shows an example of final start and end points.

FIG. 15 shows a process according to some embodiments.

FIG. 16 shows an apparatus according to some embodiments.

FIGS. 17A-17E shows a sound wave propagating towards a listener, interacting with head and ears, and the resulting ITD.

FIG. 18 shows a simplified setup for HR binaural recording.

### DETAILED DESCRIPTION

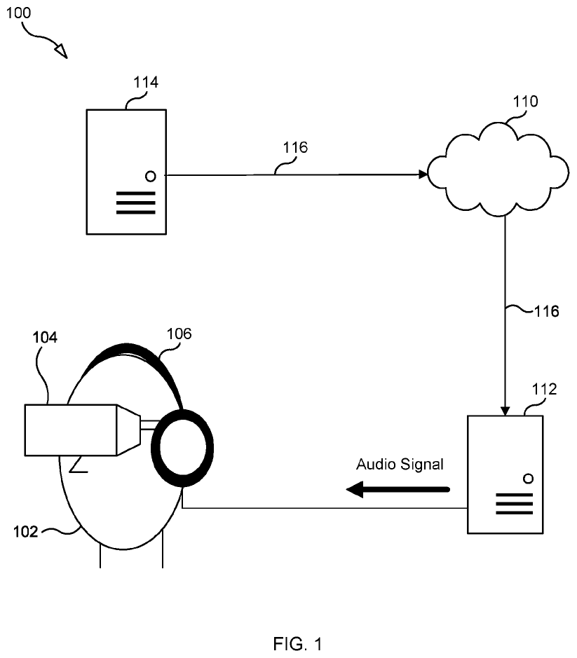

FIG. 1 shows an exemplary system 100 according to some embodiments. System 100 comprises a headphone 106, an audio rendering unit 112, and a server 114. Server 114 is configured to transmit audio data 116 to audio rendering unit 112 via network 110. Network 110 may be a wired network or a wireless network. Alternatively or additionally, network 110 may be a cloud via which audio data 116 is transmitted from server 114 to audio rendering unit 112. In this disclosure, audio data is defined as data used for, after rendering (e.g., processing with HR filter(s)), providing the listener with an audio experience as if the listener is in a three-dimensional (3D) space where audio source(s) are located. The audio data includes audio samples of source signals corresponding to audio source(s). In some embodiments, the audio data may additionally include HR filter information indicating HR filters.

After receiving audio data 116, audio rendering unit 112 may generate binaural audio signals and transmit the generated audio signals to headphone 106. Headphone 106 is configured to generate audio based on the audio signals, thereby providing user 102 with audio (also called spatial audio) experience. In some embodiments, instead of headphone 106, other audio generating devices such as an array of speakers may be used. The number of the speakers in the array can be any number larger than two.

In some embodiments, system 100 may optionally comprise an extended reality (XR) (such as virtual reality, mixed reality, or augmented reality) display headset 104. XR display headset 104 may be configured to generate different views of a virtual reality (VR) environment based on the head orientation of user 102.

XR display headset 104 may be communicatively coupled to headphone 106. For example, the XR display headset 104 may detect the head orientation of user 102, and based on the detected head orientation of user 102, the XR display headset 104 may display a different view of the VR environment and may trigger audio rendering unit 112 to generate different audio signals such that user 102 can hear different audio based on the head orientation of user 102.

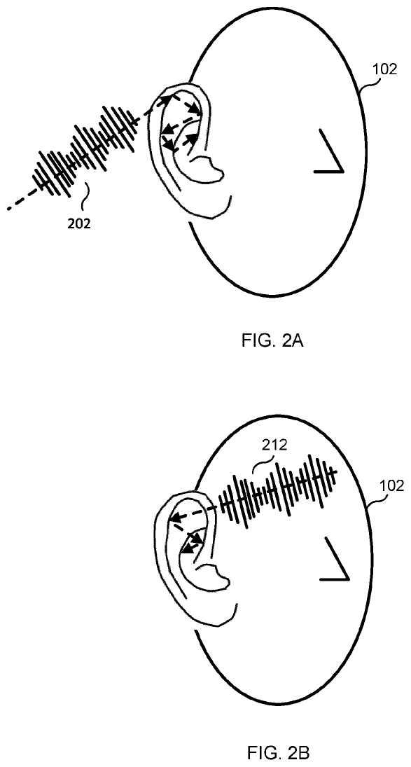

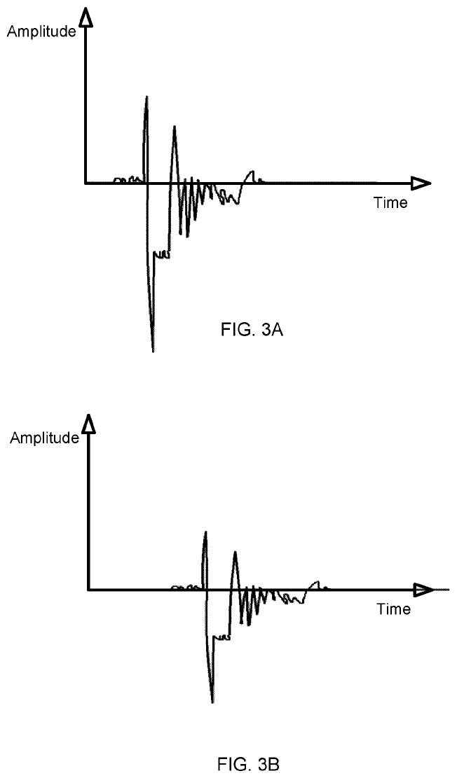

FIGS. 2A, 2B, 3A, and 3B illustrate basic concept of HR filtering.

FIG. 2A shows an audio wave 202 propagating in a first direction and reaching the right ear of user 102, and FIG. 2B shows an audio wave 212 propagating in a second direction (that is different from the first direction) and reaching the right ear of user 102. As shown in FIGS. 2A and 2B, depending on the direction of arrival (DoA) of the audio waves (with respect to the center of user 102's head), the audio waves are diffracted and/or reflected in different ways (see the paths formed by the dotted arrows in FIGS. 2A and 2B). For simple explanation, only the reflections are shown in FIGS. 2A and 2B.

HR filters are used for generating audio effects in which these different diffractions and reflections caused by different DoAs are factored. In other words, depending on the DoA of an audio wave, the audio wave goes through different temporal and spectral changes before being sensed by user 102, and mathematical representation of such temporal and spectral changes is called an HR filter. Note that the reflection paths shown in FIGS. 2A and 2B are provided for illustration purpose only and may be different from actual reflection paths in a real world environment.

FIG. 3A shows an exemplary time domain response of an HR filter for audio wave 202 and FIG. 3B shows an exemplary time domain response of an HR filter for audio wave 212. As shown in the figures, because of the different temporal and spectral changes of the audio waves, the waveforms (including the amplitude and the time of arrival (TOA) (or onset delay)) are different for audio waves 202 and 212. Note that the responses shown in FIGS. 3A and 3B are provided just to show a few aspects of the impact of the HR filters, and thus may be different from the real responses.

As discussed above, the temporal and spectral changes of an audio wave (a.k.a., “sound wave”) caused by the HR filtering vary depending on propagation direction of the audio wave.

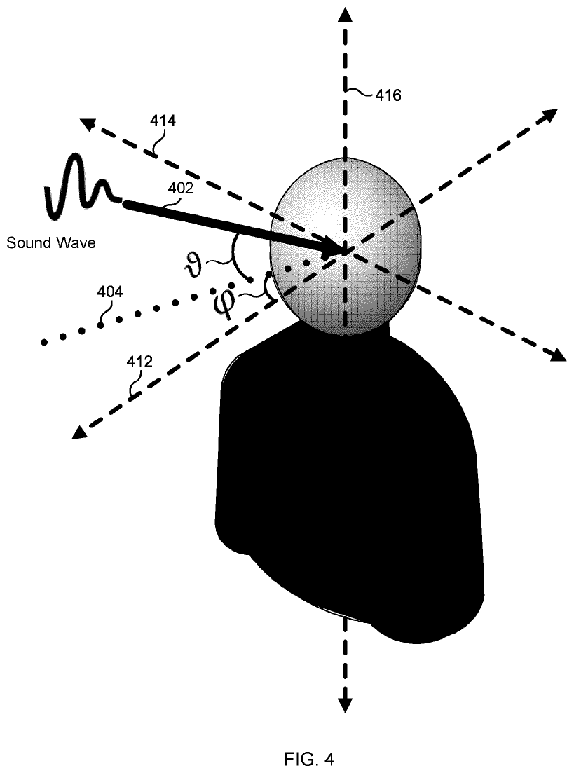

In FIG. 4, propagation vector 402 indicates the propagation direction of an audio wave within a 3D space defined by three axes 412, 414, and 416. Propagation vector 402 may be defined using two angles—azimuth angle (φ) and elevation angle (ϑ). The azimuth angle (φ) is an angle between an axis 412 (e.g., an x-axis) and a projection vector 404 corresponding to a projection of propagation vector 402 onto a plane formed by axis 412 and an axis 414. The elevation angle (ϑ) is an angle between propagation vector 402 and projection vector 404.

Since the temporal and spectral changes of an audio wave may vary depending on the azimuth angle (φ) and the elevation angle (ϑ), in some embodiments, various HR filters (which represent such temporal and spectral changes) are provided for different combinations of the azimuth angle (φ) and the elevation angle (ϑ).

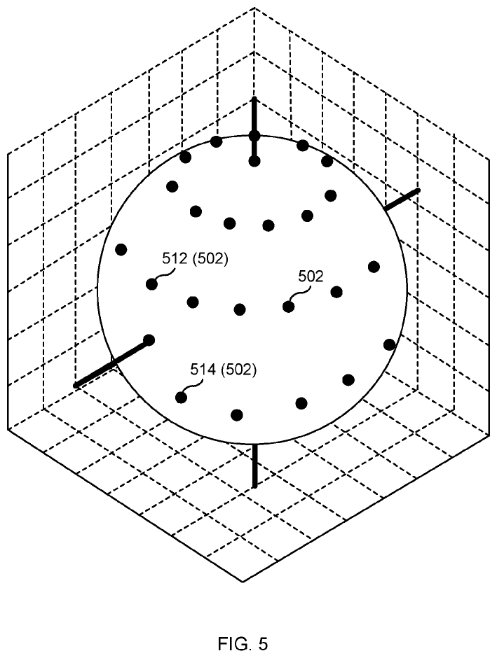

FIG. 5 shows locations on a three-dimensional (3D) sphere surrounding user 102, corresponding to a set of HR filters (a.k.a., an HR filter set) representing various temporal and spectral changes of an audio wave. The origin of the 3D sphere may correspond to the location of the head of user 102, and each dot 502 may correspond to a location of an HR filter for the left and right ears respectively. As discussed above, each HR filter may be associated with a particular combination of the azimuth angle (φ) and the elevation angle (ϑ).

The HR filter set may be used for generating audio depending on the head orientation of user 102. For example, an HR filter 512 included in the HR filter set may be used for generating audio corresponding to a first combination (φ₁, θ₁) of an azimuth angle and an elevation angle while an HR filter 514 included in the HR filter set may be used for generating sound corresponding to a second combination (φ₂, θ₂) of an azimuth angle and an elevation angle

Generally, HR filters included in the HR filter set generate a common pattern of temporal and/or spectral changes of an audio wave. However, in some scenarios, some HR filters included in the HR filter set generate temporal and/or spectral changes which are substantially deviated from the common pattern. Such set of HR filters showing the deviated patterns are called outliers or outlier HR filters.

Using an HR filter set containing such outliers to generate audio signals corresponding to an audio source may result in extreme poor spatial localization of the audio source or cause other audible degradations in spatial audio rendering. Therefore, in generating audio signals, it may be desirable to exclude such outliers or to perform additional correction process(es) to correct the incorrect performance of the outliers.

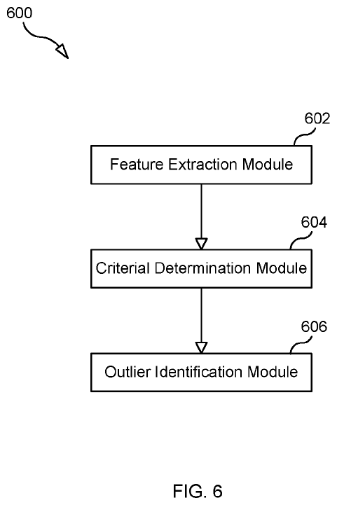

Accordingly, in some embodiments of this disclosure, an outlier detector 600 shown in FIG. 6 is used to detect one or more outliers within a set of HR filters of an HR filter dataset.

Detecting outliers among a set of HR filters of an HR filter dataset can be performed based on characteristics of the set of HR filters and identification of typical active-region, i.e. the certain time interval where the main parts of the impulse responses of HR filters typically appear. In this disclosure, the identified typical active-region of HR filters is also referred as an “effective region.” More specifically, first, a set of features that represents where the main parts of the impulse responses of HR filters locate are calculated. Second, using the set of features, a set of criteria defining the start and the end points of a time frame corresponding to the boundary of the effective region are determined. Third, using the criteria, outliers are detected.

An HR filter that is an outlier and is correctly identified as outlier is called a true positive. An HR filter that is not an outlier while is falsely identified as outlier is called a false positive. An HR filter that is an outlier while is falsely identified as normal is called a false negative. An HR filter that is not an outlier and is correctly identified as normal is called a true negative. The goal of the embodiments of this disclosure is to maximize true positives and true negatives while minimizing false positives and false negatives.

According to some embodiments, the information needed for detecting outliers are an HR filter dataset [symbol] and a set of specifications [symbol] for the outlier detection. [symbol] is the HR filter dataset under evaluation, which is typically obtained by loading the original HR filter dataset from an existing file into [symbol] is a set of specifications used by three modules included in outlier detector 600.

[symbol] Specifies method and/or parameters required by the feature extraction module.

[symbol] specifies method and/or parameters required by the criteria determination module.

[symbol] specifies method and/or parameters required by the outlier identification module.

The outlier detection process performed by outlier detector 600 involves various data variables and data representation. Notations of such data variables and data representation are explained below.

General data structures are denoted as lists of data sequences and/or lists of other data structures. A basic HR filter dataset [symbol] that contains HR filters sampled at M elevation and azimuth angles {(θ[m], φ[m]): m=1, . . . , M}, where θ and φ are the elevation and azimuth angles, respectively, and m denotes an index value, is provided in the form of the data list [symbol] ={θ, φ, H¹, H^{t}}.
θ={θ[m]: m=1, . . . , M} denotes a sequence of elevation angles.
φ={φ[m]: m=1, . . . , M} denotes a sequence of azimuth angles.
H^{l}={h^{l}[m]: m=1, . . . , M} denotes a set of left HR filters, where h^{l}[m]=[h^{l}[1; m], . . . h^{l}[n; m], . . . , h^{l}[N^{l}; m]] is a FIR filter of length N^{l}, and n is an index of the filter tap at a time instant.
H^{r}={h^{r}[m]: m=1, . . . , M} denotes the set of right HR filters, where h^{r}[m]=[h^{r}[1; m], . . . h^{r}[n; m], . . . , h^{r}[N^{l}; m]] is a FIR filter of length N^{r}, and n is an index of the filter tap at a time instant. Typically, the length of the left and the right filters are the same (meaning that N^{l}=N^{r}).

In this disclosure, for simple notation, the sub- and/or superscripts are omitted when they are not specifically needed.

Referring back to FIG. 6, outlier detector 600 may comprise a feature extraction module 602, a criterial determination module 604, and an outlier identification module 606.

Outlier detector 600 is configured to detect outliers within HR filters of an HR filter dataset based on identifying characteristics of HR filters and identifying the effective region, i.e. the certain time interval where the main parts of the impulse responses typically appear. Feature extraction module 602 is configured to extract a set of features corresponding to such characteristics (i.e., the set of features representing the certain time interval where the main parts of the impulse responses typically appear) of HR filters.

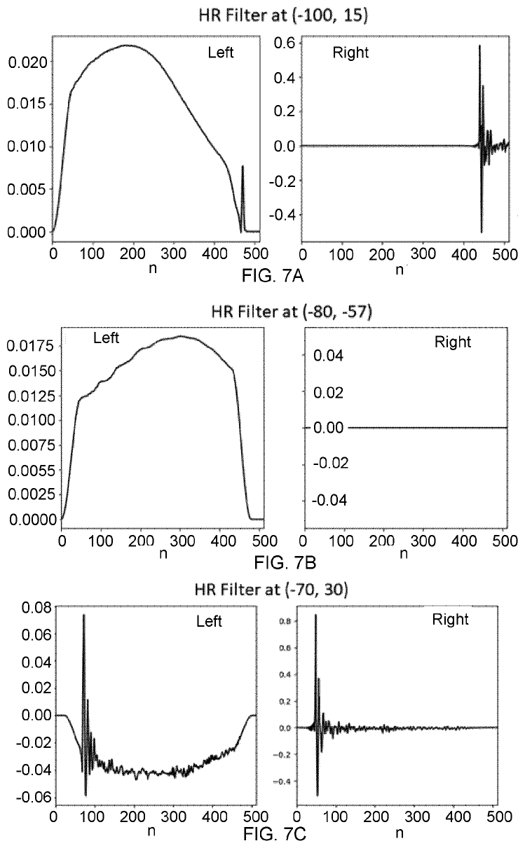

In general, a positive peak or a negative peak of an HR filter indicates the location of the strongest impulse response of the HR filter. However, the location of such peak is sensitive to noise. For example, in FIGS. 7A and 7B, left filters at the elevation and azimuth angles (−100, 15) and (−80,−57) are contaminated by high DC offset type of noise, and thus the peaks do not appear where they normally should appear. Note that, generally, the impulse response of an HR filter oscillates around zero (e.g., like the impulse response of the right HR filter shown in FIG. 7C). But, in FIGS. 7A and 7B, the impulse responses of the left HR filters increase from zero to substantial levels and stays at the levels. Thus, almost the entire portions of the left HR filters shown in FIGS. 7A and 7B are affected by such high DC offset type of noise. Therefore, simply using the peak locations as a feature for identifying the effective region of HR filters, where the main parts of the impulse responses typically appear, may result in false identification of the effective region and false detection of outliers.

In order to identify the effective region of an HR filter, which contain main parts of typical impulse responses, while providing robustness to the impact of noise, in some embodiments, two measures—i.e., Spatial Index of Dispersion (SIOD) and Temporal Index of Dispersion (TIOD)—are used, instead of the location of positive or negative peaks of the HR filters, for identifying the certain time interval of typical active-regions of the HR filters. SIOD and TIOD are developed upon index of dispersion (IOD), which is a normalized measure of the dispersion of a probability distribution.

The IOD is defined as a ratio of variance to mean, where the mean is non-zero and is generally only used for positive statistics. The mean of HR filters, however, may be negative. Thus, what is of great interest is if there is an impulse response at a time instant or not, regardless of whether the impulse response is a positive response or a negative response. Therefore, IOD is modified as a ratio of variance to normalized L1 norm instead of mean.

SIOD may be defined over an HR filter set (which may be either the left filter set H^{l} or the right filter set H^{r}) at a time instant n. For example, the SIOD measure may be calculated as follows:

$$SIOD [ n ] = \frac{\frac{1}{{M}^{′}} {\sum }_{m = 1}^{{M}^{′}} {\vert h [ n ; m ] - \frac{1}{{M}^{′}} {\sum }_{m = 1}^{{M}^{′}} h [ n ; m ] \vert}^{2}}{\frac{1}{{M}^{′}} {\sum }_{m = 1}^{{M}^{′}} \vert h [ n ; m ] \vert} . \qquad ( 1 )$$

In this case, M′=M. To calculate the SIOD curve for the entire filter set including both the left and the right filter sets, H=[H^{l}, H^{r}] and M′=2M.

SIOD measures (a.k.a., just “SIOD”) indicate an overall active-region of all HR filters in a dataset. As known, the impulse response within the active-region can be much stronger for an ipsilateral filter than a contralateral filter, and the start point of the active-region can be much earlier for an ipsilateral filter than a contralateral filter. An ideal SIOD curve is a right-skewed smooth curve. It has a single, unimodal maximum, and its value asymptotically decreases sharply as n becomes smaller than the n-value at the maximum, and slowly as n becomes larger than the n-value at the maximum.

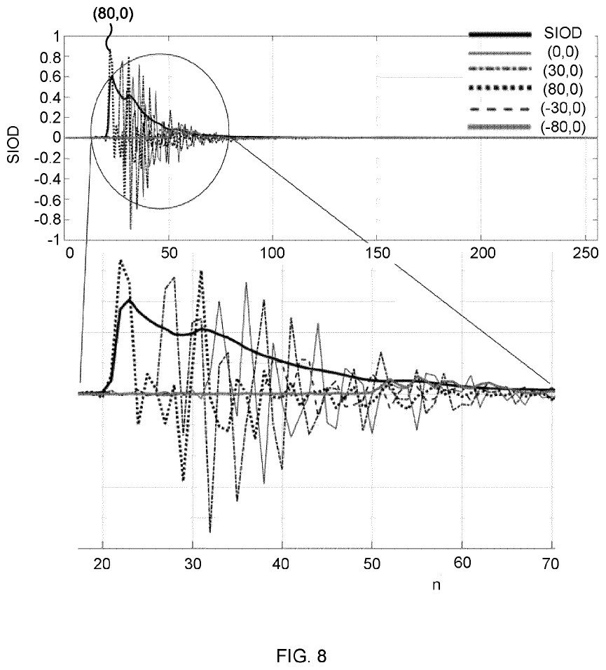

For HR filters, the “cup” area where the SIOD has a large value, corresponds to the region of n where the HR filters are most active. FIG. 8 shows an example of an SIOD curve that is calculated from the diffuse-field (DF) equalized left HR filters of the FABIAN database (https://depositonce.tu-berlin.de/handle/11303/6153.4; note that the original filters in the FABIAN database were not DF equalized).

In the upper graph of FIG. 8, the responses of the HR filters at five azimuth angles, 0 degree (middle), −30 degree (right), −80 degree (right), 30 degree (left), 80 degree (left), on the horizontal plane are plotted. It can be seen that the “cup” area (the circled portion in the upper graph of FIG. 8) where the SIOD has a large value corresponds to the region of n where the active-regions of the HR filters in the dataset appear. An enlarged portion of the circled portion is shown in the lower graph of FIG. 8.

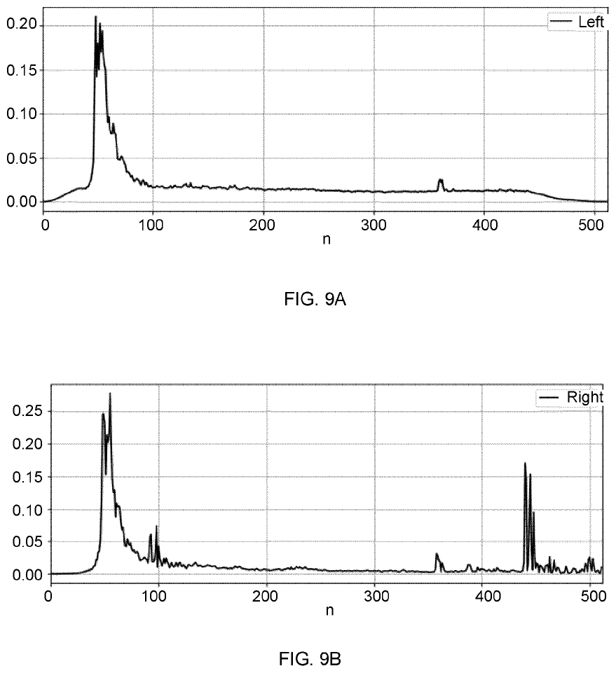

FIG. 9A shows an example of an SIOD curve for left HR filters in the HR filter dataset of Subject-19 in Princeton database, which contains outliers. Similarly, FIG. 9B shows an example of an SIOD curve for right HR filters in the HR filter dataset of Subject-19 in Princeton database, which contains outliers.

As shown in FIGS. 8, 9A, and 9B, the maximum values of the SIOD curves are data dependent. But such dependency can be removed by a min-max normalization so that the maximum value of SIOD is always 1 and the minimum values of SIOD is always 0.

TIOD may be defined over an HR filter h[m] at a time instance n. For example, the TIOD measure may be calculated as follows:

$$TIOD [ n ; m ] = \frac{{\vert h [ n ; m ] - \frac{1}{N} {\sum }_{n = 1}^{N} h [ n ; m ] \vert}^{2}}{\frac{1}{N} {\sum }_{n = 1}^{N} \vert h [ n ; m ] \vert} . \qquad ( 2 )$$

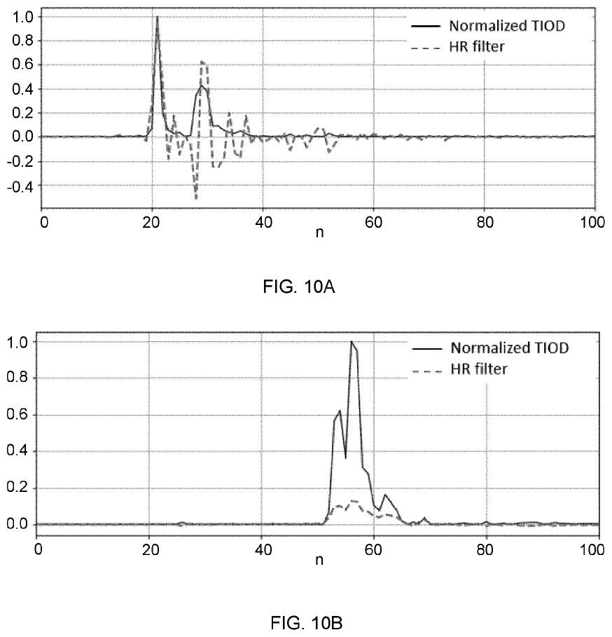

TIOD is a robust measure to detect the main part of the impulse response of an HR filter. FIG. 10A shows a TIOD curve of left HR filters (from the FABIAN database) at elevation angle of 0 degree and azimuth angle of 90 degree, where a min-max normalization is applied to have TIOD values within the range of 0 and 1. Similarly, FIG. 10B shows a TIOD curve of left HR filters (from the FABIAN database) at elevation angle of 0 degree and azimuth angle of −90 degree, where a min-max normalization is applied to have TIOD values within the range of 0 and 1.

As shown in FIG. 8, an SIOD curve may have a steep tapering on the left side, which represents the onset of an ipsilateral HR filter that has the shortest onset delay in the filter set and the strongest impulse response. Therefore, the SIOD curve may be used to identify the starting point of the main parts of the impulse responses. As also shown in FIG. 8, the SIOD curve may also have a long tail, and thus it is not easy to identify the point where the main part of the impulse response of the contralateral HR filter with the longest onset delay has started as it is delayed compared to the ipsilateral filters and has a lower energy/peak than the ipsilateral filter.

On the contrary, since a TIOD curve indicates where the HR filter has a low variance, it is a relatively robust feature to identify the point where the effective region ends. Therefore, according to some embodiments, feature extraction module 602 may be configured to extract SIOD and TIOD from the dataset [symbol] . In some embodiments, SIOD and/or TIOD may be specified in [symbol] as features to extract from [symbol] .

After feature extraction module 602 extracts SIOD and TIOD values (corresponding to an SIOD curve and a TIOD curve), criteria determination module 604 may determine a set of criteria for detecting outliers based on the extracted SIOD and TIOD values. The set of outlier detection criteria may define the effective region of HR filters. The effective region is a region (time interval) within which the main part of the impulse response of any HR filter in the dataset should be located, i.e., covering the typical active-regions of the HR filter set. In determining the set of outlier detection criteria, two steps may be performed.

The first step of determining the set of outlier detection criteria is obtaining an initial start point and an initial end point, which collectively define an initial effective region. Here, the initial start point should be early enough to make sure that ipsilateral filters are included within the initial effective region, and the initial end point should be early enough to make sure that filters with extra-long onset delay are excluded from the initial effective region.

The second step of determining the set of outlier detection criteria is obtaining a final start point and a final end point, which collectively define a final effective region. Here, the final start point is determined based on the initial start point, aiming to exclude filters with extra-short onset delay. Similarly, the final end point is determined based on the initial end point, aiming to make sure normal (typical) contralateral filters are included.

Thresholding is one of the efficient methods to determine the boundaries of the effective region. Some thresholds may be fixed constants specified in [symbol] , and some thresholds may be calculated dynamically given the extracted features. More details of the thresholding are provided below.

In principle, identifying outliers is about evaluating where the active-region of a typical HR filter is located, i.e., identifying the typical active-regions. One method, for example, is to locate the peak of the TIOD curve of an HR filter and to determine whether it is outside the effective region (i.e., the region where the main part of the impulse should be located). However, this method may not be capable of detecting undesired large amount of DC offset.

In order to also detect such undesired DC offset, the ratio of the energy within the effective region to the total energy of the HR filter may be analyzed. If the ratio is smaller than a threshold, the HR filter is considered an outlier. The method associated with some parameters, if there is any, to identify outliers may be specified in [symbol] .

The output of outlier detector 600 is labeled as [symbol] . It may be a set of labels indicating for each HR filter in the dataset if it is detected as an outlier or not, as illustrated in the table below.

| HR filter list | Outlier (true/false) |
|---|---|
| HR filter #1 | True |
| HR filter #2 | False |
| HR filter #3 | True |

Alternatively, [symbol] may be a list of indices of the HR filters that have been detected as outliers. Thus, in the example provided in the table above, [symbol] may include a list of index value #1 and index value #3.

If no outlier has been detected, [symbol] may only be an indicator indicating that no outlier has been found in the HR filter dataset.

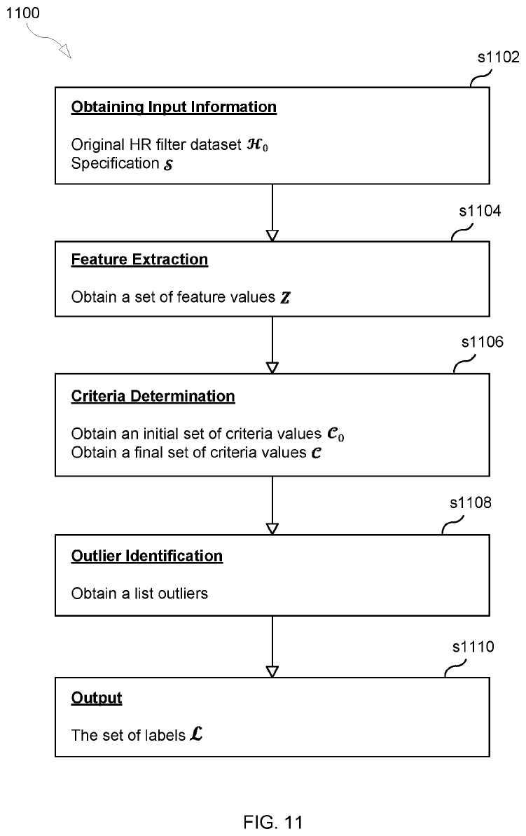

FIG. 11 shows a process 1100 for detecting outliers from among a set of HR filters of an HR filter dataset, according to some embodiments, which is explained with respect to FIG. 1. Process 1100 may be performed by server 114 which is configured to transmit audio data 116 to audio renderer 112. Alternatively, process 1100 may be performed by audio renderer 112.

Process 1100 may begin with step s1102. Step s1102 comprises obtaining input information needed for detecting outliers. For example, in case process 1100 is performed by audio renderer 112 or server 114, audio renderer 112 or server 114 may obtain the input information by receiving the input information from another entity and/or by retrieving the input information from its memory. More specifically, in case process 1100 is performed by audio renderer 112, in one example, the input information may be included in audio data 116.

The input information may comprise an HR filter dataset [symbol] and a set of specifications [symbol] for outlier detection. [symbol] is the HR filter dataset under evaluation, which is typically obtained by loading the original HR filter dataset from an existing file into [symbol] = [symbol] is a set of specifications used by the three modules 602-606.

After obtaining the input information, process 1100 may proceed to step s1104. Step s1104 comprises extracting a set Z of feature values which indicate where the active-regions of the set of HR filters of the HR filter dataset [symbol] are located. Z contains feature values extracted from [symbol] according to the feature extraction method specified in the feature extraction setting [symbol] .

In some embodiments, the feature extraction setting [symbol] indicates that SIOD and TIOD are the features to extract for outlier detection. In such embodiments, Z={z_{S}, z_{T}}, where z_{S} represents a set of SIOD values and z_{T} represents a set of TIOD values.

The SIOD values may be calculated for the left filter set

$${H}_{0}^{1}$$

and the right minter set

$${H}_{0}^{r} ,$$

respectivel. Thus, z_{S} may be represented as:

z_{S}={SIOD^{l},SIOD^{r}}={SIOD^{l}[n^{l}]: n^{l}=1, . . . ,N^{l}},{SIOD^{r}[n^{r}]: n^{r}=1, . . . ,N^{r}}.

Since the two sets of left and right HR filters

$${H}_{0}^{1} and {H}_{0}^{r}$$

follow essentially the same pattern and they usually have the same data structure (e.g., N^{l}=N^{r}=N), it is reasonable to calculate one SIOD curve for the combined sets

$$[ {H}_{0}^{1} , {H}_{0}^{r} ] .$$

z_{S} may then be represented as:

z_{S}={SIOD}={SIOD[n]: n=1, . . . ,N}.

As discussed above, in some embodiments, the set z_{S} of the SIOD values are calculated using Equation (1). On the other hand, the set z_{T} of TIOD values are calculated using Equation (2).

z_{T} may be represented as:

$${z}_{T} = \{ {TIOD}^{1} , {TIOD}^{r} \} = \{ {TIOD}^{1} [ {n}^{1} ; m ] , {TIOD}^{r} [ {n}^{r} ; m ] : {n}^{1} = 1 , … , {N}_{I}^{1} , {n}^{r} = 1 , … , {N}_{I}^{r} , m = 1 , … , M \} .$$

After extracting the sets of feature values in step s1104, process 1100 may proceed to step s1106. Step s1106 comprises determining a set of criteria values for detecting outliers from among a set of HR filters of HR filter dataset [symbol] . More specifically, in step s1106, using the set Z of feature values (e.g., the set of SIOD values and the set of TIOD values), a set of criteria values may be determined. The set of criteria values indicates the start point and the end point of the effective region (i.e., an effective time interval) within which the main part of the impulse response of any HR filter in the dataset should be located (or typically is located).

The start point should be early enough such that the effective region includes/covers ipsilateral filters that have short onset delay and, at the same time, the start point should be late enough such that the filters with extra-short onset delay are excluded from (are not covered by) the effective region. The end point should also be late enough such that the effective region includes/covers the contralateral filters that have long onset delay, and at the same time, the end point should be early enough such that filters with extra-long onset delay are excluded from (are not covered by) the effective region.

As shown in FIG. 11, the step of determining outlier detection criteria contains two sub-steps: (1) obtaining an initial set of criteria values [symbol] and (2) obtaining a final set of criteria values

[symbol]

Sub-Step (1)—Obtaining the Initial Set of Criteria Values

[symbol]

The initial set [symbol] of criterial values may contain two elements— [symbol] ={nₛ₀, nₑ₀}, where nₛ₀ denotes the initial start point and neo denotes the initial end point. The initial start point and the initial end point define an initial effective region.

The SIOD feature values extracted in step s1104 may be used to estimate the initial start point nₛ₀. For example, using a thresholding method, nₛ₀ can be obtained by:

$${n}_{s 0} = {argmin}_{n} ( \text{?} [ n ] > {η}_{s 0} ) ,$$

where [symbol] denotes the normalized cumulative sum of SIOD values,

$$\text{?} [ n ] = \frac{{\sum }_{{n}^{′} = 1}^{n} \text{?} [ {n}^{′} ]}{{\sum }_{{n}^{′} = 1}^{N} \text{?} [ {n}^{′} ]} .$$

The smaller the value of the threshold ηₛ₀ is, the smaller the value of the initial start point nₛ₀ would be. In some embodiments, a small value of ηₛ₀ is recommended to minimize false negative rate so that ipsilateral HR filters are not likely to be detected as outliers. The value of [symbol] may be within [0, 1]. One example of ηₛ₀ is 0.01.

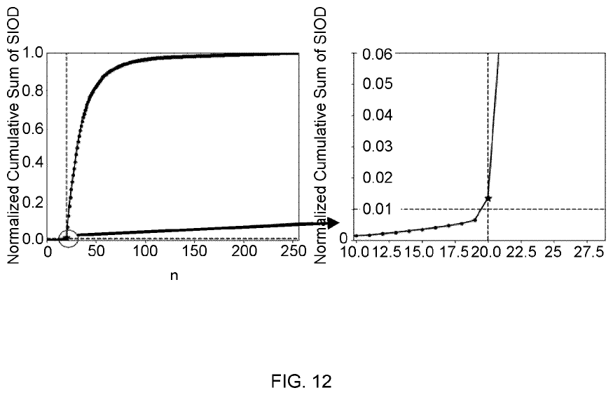

FIG. 12 shows an example of determining the initial start point using the described thresholding method with ηₛ₀=0.01. In FIG. 12, FABIAN database is used. Here, the initial start point is found to be nₛ₀=20 given the threshold ηₛ₀=0.01.

After determining the initial start point nₛ₀, the initial end point nₑ₀ may be determined as follows.

The active-region of the impulse responses of an HR filter usually appears early for ipsilateral HR filters and late for contralateral HR filters. Ipsilateral filters usually have high signal-to-noise ratio (SNR). The location of the active-region of an ipsilateral filter can be accurately represented by the peak location of its TIOD curve. However, contralateral filters have weak impulse responses, and thus can be easily contaminated by noise. There may be peaks at similar level as caused by noise.

In order to capture such abnormality, for contralateral filters, instead of using the location of single TIOD maxima, it may be effective to average out over an area where TIOD is greater than a threshold.

For example, let [symbol] ={ [symbol] [m], [symbol] [m]: m=1, . . . , M} denote a list of the peak locations of the TIOD curves. For ipsilateral filter,

$${𝓃}^{l / r} [ m ] = {argmax}_{n} ( {TIOD}^{l / r} [ n , m ] ) .$$

For contralateral filters,

$${𝓃}^{l / r} [ m ] = mean ( {argfind}_{n} ( {TIOD}^{l / r} [ n , m ] > {η}_{n} ) ) .$$

A typical value of ηₙ could be 0.5 given that the TIOD feature is min-max normalized and has the value in [0, 1].

Let [symbol] ={ [symbol] [i]: i=1, . . . , 1} be the vector containing the unique elements in [symbol] , which is sorted in ascending order. I is the total number of unique elements.

A frequency density of the TIOD peak locations can be estimated by

$$Pr [ i ] = \frac{{\tilde{ℜ}}_{i}}{2 M} .$$

[symbol]

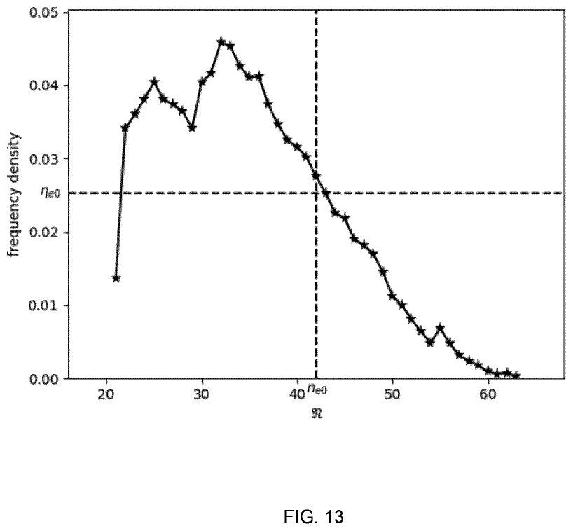

is the number of counts of [symbol] [i] occurred in [symbol] and Pr[i] denotes the frequency density of the peak location [symbol] [i]. The curve in FIG. 13 plots an example of such a frequency density calculated from FABIAN database. The start and the end of the curve correspond to the locations of active-region of ipsilateral filters and the contralateral filters, respectively. To make sure that filters with extra long onset delay are excluded, an early initial end point is preferred.

Using a thresholding method, nₑ₀ may be obtained by:

$${n}_{e 0} = ℜ [ {argmax}_{n} ( Pr [ i ] > {η}_{e 0} ) ] .$$

ηₑ₀ is determined by computing the q₀-th percentile of the frequency density. The larger the value of q₀, the larger the threshold ηₑ₀, and the smaller the value of nₑ₀.

FIG. 13 shows an example of determining the initial end point nₑ₀, where the threshold ηₑ₀ is obtained by the 50-th percentile of the frequency density of the active-region locations (FABIAN database is used in this example).

Sub-Step (2)—Obtaining the Final Set of Criteria Values

[symbol]

The principle for the adjustment of the initial start and end points is based on the fact that the location of the active-region is likely to be a continuous function of direction, and therefore, [symbol] is likely to be a sequential set. In other words, the likelihood of having a large difference between two adjacent elements in [symbol] is low. Let Δ [symbol] ={Δ [symbol] [i]: i=1, . . . , l−1}, where Δ [symbol] [i]= [symbol] [i+1]− [symbol] [i], which should be smaller than a threshold η_{Δ}. If Δ [symbol] >η_{Δ}, it is likely caused by outliers. A larger value of η_{Δ} may cause a higher number of false positives and a smaller value of η_{Δ} may cause a higher number of false negatives. η_{Δ}=2 or 3 seems to give a good balance.

However, this is not valid for a spatially sparsely sampled HR filter set, particularly sparsely sampled on the azimuth angles, where the cause of Δ [symbol] greater than the threshold is the large difference between the sampled azimuth angles. In this case, even though Δ [symbol] is greater than η_{Δ}, the frequency density of [symbol] is usually relatively high for typical peak locations. This differentiates the spatially sparsely sampled HR filters from outliers. Therefore, another condition on the frequency density is introduced, which is Pr[i]<ηₚ, where ηₚ is determined by computing the q₁-th percentile of the frequency density. The larger the value of q₁, the larger the threshold ηₚ. A large threshold may cause a high number of false negatives. The smaller the value of q₁, the smaller the threshold ηₚ. A small threshold may cause a high number of false positives. A value of q₁=25 seems to give a good balance.

The final set of criteria values includes a final start point and a final end point, which collectively define an effective region for identifying outliers. The final start point n_{S} may be obtained as follows.

Given [symbol] , a list of peak locations, denoted by [symbol] , each satisfying the following three conditions is obtained:
1) The peak location is located before the initial end point, [symbol] [i]<nₑ₀.
2) The peak location's distance from the next peak location is larger than the threshold η_{Δ}, Δ [symbol] [i]>η_{Δ}.
3) The peak location's frequency density is lower than the threshold ηₚ, Pr[i]<ηₚ.

The final start point may be obtained by nₛ=max(nₛ₀, min( [symbol] >max( [symbol] ))).

On the other hand, the final end point nₑ may be obtained as follows.

Given [symbol] , a list of peak locations, denoted by [symbol] , each satisfying all the three conditions may be obtained:
1) The peak location is located after the initial end point, [symbol] [i]>nₑ₀.
2) The peak location's distance from the next peak location is larger than the threshold n_{Δ}, Δ [symbol] [i]>η_{Δ}.
3) The peak location's frequency density is lower than the threshold ηₚ, Pr[i]<ηₚ.

The final end point may be obtained by nₑ=max (nₑ₀, max( [symbol] ≤min( [symbol] ))). The peak location [symbol] is a point estimator corresponding to a point location where the strongest impulse response likely appears. However, the main parts of the impulse responses appear within a certain time frame. Therefore, using peak locations without considering the spread of the impulse responses may result in high false positive, where some normal (typical) contralateral filters may be identified as outliers.

Taking into account the spread of impulse responses of filters, the final end point may then further be updated by nₑ=nₑ+n̅_{spread}. n̅_{spread} is the average value of the spread of filters, where the spread of a filter n_{spread} is calculated from TIOD by

$${n}_{spread} [ m ] = max ( {argfind}_{n} ( TIOD [ n , m ] > {η}_{spread} ) ) - min ( {argfind}_{n} ( TIOD [ n , m ] > {η}_{spread} ) ) .$$

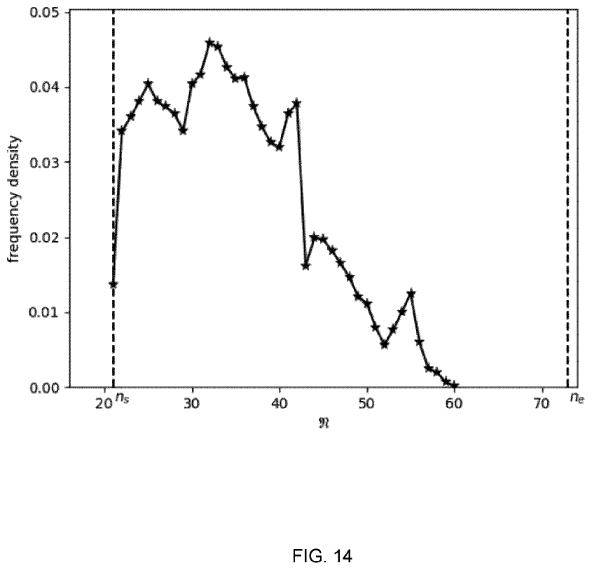

A typical value of η_{spread} is 0.1 given that TIOD feature is min-max normalized. FIG. 14 shows an example of the final start/end points where the typical values of the parameters are used, i.e., η_{Δ}=2, η_{spread}=0.1, and q₁=25. FABIAN database is used in this example.

Here is a summary of the parameters that may be used in determining outlier detection criteria. ηₛ₀, and q₀ are the parameters for obtaining the initial start/end points. η_{Δ}, η_{spread}, and q₁ are the parameters for obtaining the final start/end points. In some embodiments, the parameters are specified in [symbol] (e.g., by users).

As discussed above, the two sets of HR filters

$${H}_{0}^{1} and {H}_{0}^{r}$$

follow essentially the same pattern. Thus, in some embodiments, one common effective region is determined for both left and right filter sets. Then the set of criteria values contains only two elements, [symbol] =[nₛ, nₑ], where nₛ is the start point of the effective region and nₑ is the end point of the effective region. On the contrary, in other embodiments, the effective region may be determined separately for the left and the right filter set. In such embodiments, the set of criteria may contain four elements

$$𝒞 = [ {n}_{s}^{I} , {n}_{e}^{l} , {n}_{s}^{r} , {n}_{e}^{r} ] .$$

After performing step s1106, process 1100 may proceed to step s1108. Step s1108 comprises detecting outliers from among a set of HR filters of the HR filter dataset [symbol] using the set of outlier criteria

$$( i . e . , 𝒞 = [ {n}_{s}^{I} , {n}_{e}^{l} , {n}_{s}^{r} , {n}_{e}^{r} ] )$$

determined in step s1106. The outliers may be detected using the outlier detection method specified in specification

[symbol]

One exemplary simple method for detecting the outliers is to locate the peak of the TIOD curve of each HR filter in the dataset. If the peak is located outside the effective region defined by [symbol] , the HR filter is labelled as an outlier.

However, this method is not capable of detecting noise, e.g., the left HR filter at (−80, −57) in FIG. 7B. To detect such noise, according to some embodiments, the ratio of the energy within the effective region to the total energy of the HR filter may be used. For example, let γ[m] denotes the energy ratio of an HR filter h[m],

$$γ [ m ] = \frac{{\sum }_{n = {n}_{s}}^{{n}_{e}} {( h [ n , m ] - \frac{1}{N} {\sum }_{n = 1}^{N} h [ n ; m ] )}^{2}}{{\sum }_{n = 1}^{N} {( h [ n , m ] - \frac{1}{N} {\sum }_{n = 1}^{N} h [ n ; m ] )}^{2}} .$$

In the above formula, the mean is removed, and the energy ratio is not sensitive to DC offset. However, it may fail to detect HR filters with undesired DC offset, e.g., the left filter at (−70, 30) in FIG. 7C. Therefore, in addition, another energy ratio is calculated as:

$$γ [ m ] = \frac{{\sum }_{n = {n}_{s}}^{{n}_{e}} {( h [ n , m ] )}^{2}}{{\sum }_{n = 1}^{N} {( h [ n , m ] )}^{2}}$$

If either of the ratios is smaller than a threshold, the HR filter h[m] is labelled an outlier. A typical value for the threshold may be 0.5. Considering that the SNR of an ipsilateral filter is in general higher than the SNR of a contralateral filter, an azimuth-dependent threshold is more suitable than a fixed value. An example of such threshold can be a Sigmoid-like function, e.g.,

$$\frac{1}{1 + {e}^{- sin \frac{ϕ}{2}}}$$

for the left HR filters and

$$1 - \frac{1}{1 + {e}^{- sin \frac{ϕ}{2}}}$$

for the right HR filters so that the threshold for an ipsilateral filter is higher than the one for a contralateral filter. In some embodiments, the threshold is specified in [symbol] (e.g., by users). In the above embodiments, a single threshold is used for comparisons with different ratios. However, in other embodiments, a different threshold may be provided for a comparison with a different ratio.

After detecting the outliers in step s1108, process 1100 may proceed to step s1110. Step s1110 comprises outputting a set [symbol] of labels. As discussed above, in some embodiments, the set may indicate whether each HR filter included in the HR filter dataset is an outlier or not, while, in other embodiment, the set only includes a list of index values identifying the outliers or only includes a list of index values identifying non-outliers.

Referring back to FIG. 1, after obtaining the set of outlier labels, the set of outlier labels may be provided to audio rendering unit 112. For example, the set of outlier labels may be provided from server 114 to audio rendering unit 112 or may be detected directly by audio rendering unit 112 using process 1100 described above.

After obtaining the set of outlier labels, audio rendering unit 112 may generate audio signals (to be provided to speakers 106 and 108) using the set of outlier labels. In one example, in case the set of HR filters that audio rendering unit 112 is to use for generating the audio signals contains outliers, audio rendering unit 112 may exclude the outliers from the set of HR filters and use the set of HR filters from which the outliers are excluded, in generating the audio signals.

In another example, in case the set of HR filters that audio rendering unit 112 is to use for generating the audio signals contains outliers, audio rendering unit 112 may not use the set of HR filters for generating the audio signals, and may use another set of HR filters that does not include any outlier. In some embodiments, whether to use the set of HR filters containing the outliers for generating the audio signals may be determined based on the number of outliers. For example, in case the number of outliers is less than a threshold value, audio rendering unit 112 may use the set of HR filters (with or without the outliers) while, in case the number of outliers is greater than or equal to the threshold value, audio rendering unit 112 may use a different set of HR filters that contains no outlier or that contains a number of outliers which is less than the threshold value.

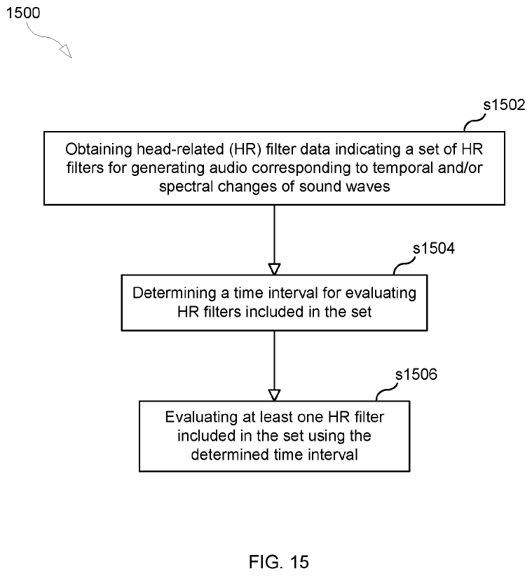

FIG. 15 shows a process 1500 according to some embodiments. Process 1500 may begin with step s1502. Step s1502 comprises obtaining head-related, HR, filter data indicating a set of HR filters for generating audio corresponding to temporal and/or spectral changes of sound waves. Step s1504 comprises determining a time interval for evaluating HR filters included in the set. Step s1506 comprises evaluating at least one HR filter included in the set using the determined time interval. Audio is generated based on the evaluation.

In some embodiments, process 1500 comprises, based on the evaluation, performing one or more of: (i) labeling said at least one HR filter for generating audio; (ii) selecting a different set of HR filters for generating audio; or (ii) not using said at least one HR filter for generating audio.

In some embodiments, process 1500 comprises generating updated HR filter data indicating an updated set of HR filters, wherein the updated set of HR filters (i) includes the labeled at least one HR filter, (ii) excludes the labeled at least one HR filter, (iii) is the different set of HR filters, or (iv) excludes said at least one HR filter; and (i) storing and/or transmitting updated HR filter data and/or (ii) generating audio using the updated HR filter data.

In some embodiments, process 1500 comprises, using the obtained HR filter data, calculating a first set of feature values and/or a second set of feature values, wherein a feature value included in the first set and/or a feature value included in the second set indicates where a portion of impulse response of said at least one HR filter is located in a temporal domain.

In some embodiments, the feature value included in the first set and/or the feature value included in the second set is a normalized measure of dispersion of the impulse responses of the HR filters included in the set of HR filters and/or a normalized measure of dispersion of the impulse response of the HR filters.

In some embodiments, each feature value included in the first set is a spatial index of dispersion, SIOD, and each feature value included in the second set is a temporal index of dispersion, TIOD.

In some embodiments, each feature value included in the first set is SIOD[n], where n is an index of an HR filter tap at a time instant, and

$$SIOD [ n ] = \frac{\frac{1}{{M}^{′}} {\sum }_{m = 1}^{{M}^{′}} \vert h [ n ; m ] - \frac{1}{{M}^{′}} {\sum }_{m = 1}^{{M}^{′}} h [ n ; m ] \vert}{\frac{1}{{M}^{′}} {\sum }_{m = 1}^{{M}^{′}} \vert h [ n ; m ] \vert} ,$$

where
M′ is either a number of HR filters included in the set or ½ of the number of HR filters included in the set of HR filters, m is a filter index of an HR filter included in the set of HR filters, and h[n; m] is a value of an HR filter having an index value of m at an HR filter tap n.

In some embodiments, each feature value included in the second set is TIOD[n], where n is an index of an HR filter tap at a time instant, and

$$TIOD [ n ; m ] = \frac{{\vert h [ n ; m ] - \frac{1}{N} {\sum }_{n = 1}^{N} h [ n , m ] \vert}^{2}}{\frac{1}{N} {\sum }_{n = 1}^{N} \vert h [ n ; m ] \vert} ,$$

where
N is length of an HR filter included in the set of HR filters, m is a filter index of an HR filter included in the set of HR filters, and h[n; m] is a value of an HR filter having an index value of m at an HR filter tap n.

In some embodiments, determining the time interval comprises: calculating an initial start time of the time interval using the feature values included in the first set, and/or calculating an initial end time of the time interval using the feature values included in the second set.

In some embodiments, the initial start time of the time interval is calculated based on a normalized cumulative sum of the feature values included in the first set and a threshold value for determining the initial start time.

In some embodiments,

$${n}_{s 0} = {arg min}_{n} ( \text{?} [ n ] > {η}_{s 0} ) ,$$

where
nₛ₀ is the initial start time of the time interval, n is a positive integer, [symbol] [n] is the normalized cumulative sum of the feature values included in the first set, ηₛ₀ is the threshold value for determining the initial start time.

In some embodiments, the second set of feature values (e.g., a set containing TIOD curve #1,TIOD curve #2, . . . , etc.) comprises a plurality of subsets (e.g., TIOD curve #1 corresponding to HR filter #1, TIOD curve #2 corresponding to HR filter #2, . . . , etc.) of feature values, each feature value (e.g., TIOD value #1 of TIOD curve #1, TIOD value #2 of TIOD curve #1) included in each subset of feature values is identified by an index value, in each subset of feature values, the highest feature value among the feature values is identified by a peak index value, and the initial end time of the time interval is calculated based on frequency densities of the peak index values of the plurality of subsets.

In some embodiments, the initial end point neo is evaluated as

$${n}_{e 0} = 𝔑 [ {arg max}_{i} ( Pr [ i ] > {η}_{e 0} ) ] ,$$

where
Pr[i] is a frequency density of a peak index value i, the frequency density of the peak index value i indicates how many times the peak index value i identifies the highest feature value among feature values included in each subset of feature values for the plurality of subsets, i is a positive integer, 1≤i≤I, I is a number of the peak index values included in [symbol] , [symbol] is a set of the peak index values, ηₑ₀ is a threshold value for determining the initial end time, and

$$𝔑 [ {arg max}_{i} ( Pr [ i ] > {η}_{e 0} ) ]$$

is a peak index value included in [symbol] , which corresponds to an index of

$${arg max}_{i} ( Pr [ i ] > {η}_{e 0} ) .$$

In some embodiments, determining the time interval comprises: obtaining a group ( [symbol] ) of peak index values; and calculating an adjusted start time of the time interval based on the initial start time of the time interval and the group of peak index values.

In some embodiments, each peak index value included in the group of the peak index values satisfies the following conditions: the peak index value corresponds to a location which is before the initial end time of the time interval, a difference between the peak index value and a next peak index value within a set of peak index values arranged in ascending order is greater than a threshold value, and a frequency density of the peak index value is lower than a threshold density value.

In some embodiments, the adjusted start time nₛ is calculated as nₛ=max(nₛ₀, min( [symbol] >max( [symbol] ))), where nₛ₀ is the initial start time, [symbol] is the set of peak index values, and [symbol] is the group of peak index values.

In some embodiments, determining the time interval comprises: obtaining a group ( [symbol] ) of peak index values; and calculating an adjusted end time of the time interval based on the initial end time of the time interval and the group of peak index values.

In some embodiments, each peak index value included in the group satisfies one or more of the following conditions: the peak index value indicates a location which is after the initial end time of the time interval, a difference between the peak index value and a next peak index value within a set of peak index values arranged in ascending order is greater than a threshold value, and a frequency density of the peak index value is lower than a threshold density value.

In some embodiments, the adjusted end time nₑ is calculated as nₑ=max(nₑ₀, max( [symbol] ≤min( [symbol] ))), where nₑ₀ is the initial end time, [symbol] is the set of peak index values, and [symbol] is the group of peak index values.

In some embodiments, evaluating at least one HR filter included in the set using the determined time interval comprises: calculating a first amount of energy of said at least one HR filter within the time interval; and calculating a total amount of energy of said at least one HR filter.

In some embodiments, evaluating at least one HR filter included in the set using the determined time interval comprises: determining one or more ratios each of which is a ratio of the first amount of energy and the total amount of energy; and labeling said at least one HR filter based on the determined said one or more ratios.

In some embodiments, evaluating at least one HR filter included in the set using the determined time interval comprises: comparing each of said one or more ratios to at least one threshold value; and labeling said at least one HR filter in case at least one of said one or more ratios is smaller than said at least one threshold value.

In some embodiments, said at least one HR filter is associated with a particular angle, and said at least one threshold value is determined based on the particular angle.

In some embodiments, evaluating at least one HR filter included in the set using the determined time interval comprises evaluating an m-th HR filter, h[m], associated with an index value m,

$$γ [ m ] = \frac{{\sum }_{n = {n}_{s}}^{{n}_{e}} {( h [ n , m ] - \frac{1}{N} {\sum }_{n = 1}^{N} h [ n , m ] )}^{2}}{{\sum }_{n = 1}^{N} {( h [ n , m ] - \frac{1}{N} {\sum }_{n = 1}^{N} h [ n , m ] )}^{2}} ,$$

where γ is one of said one or more ratios, h[n, m] is an impulse response of the m-th HR filter at an HR filter tap n, nₛ is a starting time of the time interval, and nₑ is an ending time of the time interval, and each of n and m is a positive integer.

In some embodiments, evaluating at least one HR filter included in the set using the determined time interval comprises evaluating an m-th HR filter, h[m], associated with an index value m,

$$γ [ m ] = \frac{{\sum }_{n = {n}_{s}}^{{n}_{e}} {( h [ n , m ] )}^{2}}{{\sum }_{n = 1}^{N} {( h [ n , m ] )}^{2}} ,$$

where γ is one of said one or more ratios, h[n, m] is an impulse response of the m-th HR filter at an HR filter tap n, nₛ is a starting time of the time interval, and nₑ is an ending time of the time interval, and each of n and m is a positive integer.

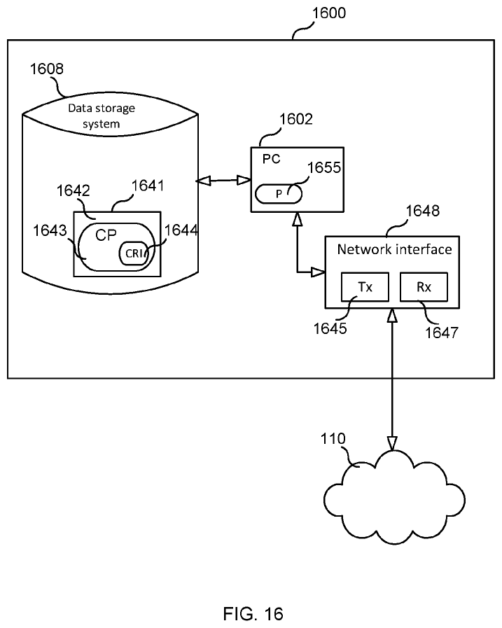

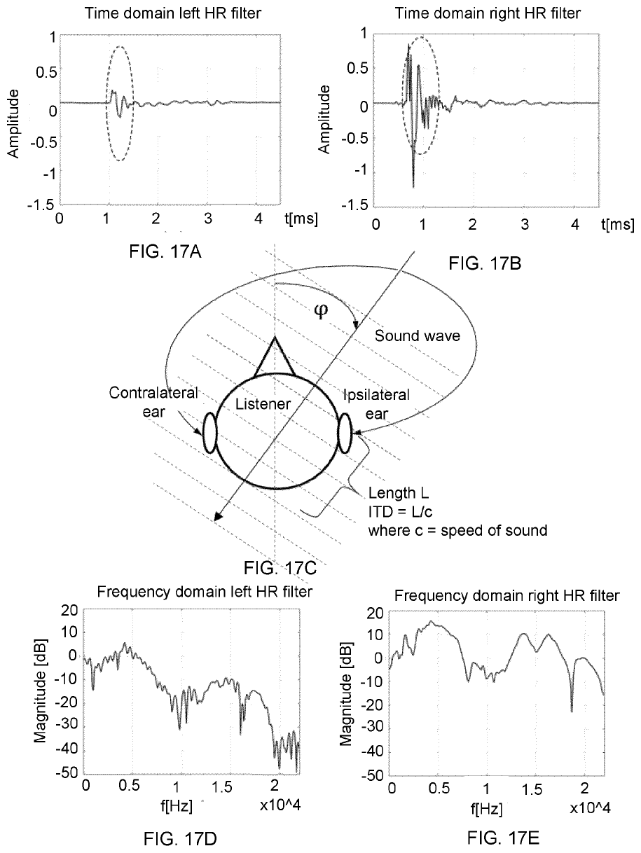

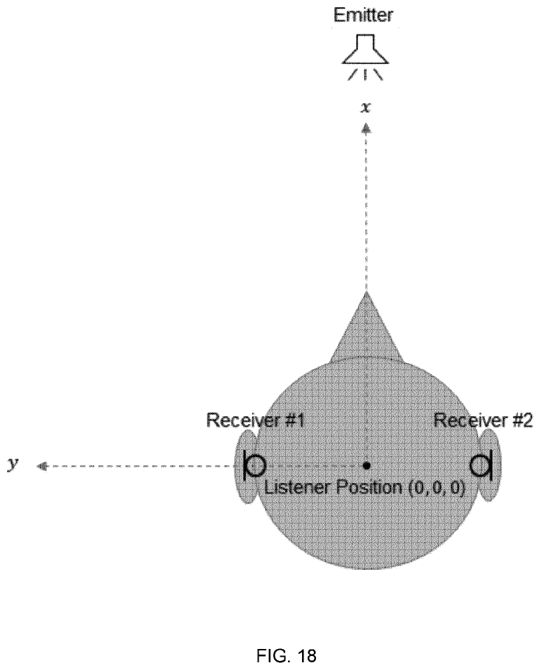

FIG. 16 is a block diagram of an apparatus 1600, according to some embodiments, for implementing audio rendering unit 112 and/or server 114. As shown in FIG. 16, apparatus 1600 may comprise: processing circuitry (PC) 1602, which may include one or more processors (P) 1655 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1600 may be a distributed computing apparatus); at least one network interface 1648, each network interface 1648 comprises a transmitter (Tx) 1645 and a receiver (Rx) 1647 for enabling apparatus 1600 to transmit data to and receive data from other nodes connected to a network 110 (e.g., an Internet Protocol (IP) network) to which network interface 1648 is connected (directly or indirectly) (e.g., network interface 1648 may be wirelessly connected to the network 110, in which case network interface 1648 is connected to an antenna arrangement); and one or more storage units (a.k.a., “data storage system”) 1608, which may include one or more non-volatile storage devices and/or one or more volatile storage devices. In embodiments where PC 1602 includes a programmable processor, a computer program product (CPP) 1641 may be provided. CPP 1641 includes a computer readable medium (CRM) 1642 storing a computer program (CP) 1643 comprising computer readable instructions (CRI) 1644. CRM 1642 may be a non-transitory computer readable medium, such as, magnetic media (e.g., a hard disk), optical media, memory devices (e.g., random access memory, flash memory), and the like. In some embodiments, the CRI 1644 of computer program 1643 is configured such that when executed by PC 1602, the CRI causes apparatus 1600 to perform steps described herein (e.g., steps described herein with reference to the flow charts). In other embodiments, apparatus 1600 may be configured to perform steps described herein without the need for code. That is, for example, PC 1602 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method comprising:
obtaining head-related, HR, filter data indicating a set of HR filters for generating audio corresponding to temporal and/or spectral changes of sound waves;
determining a time interval for evaluating HR filters included in the set; and
evaluating at least one HR filter included in the set using the determined time interval, wherein
audio is generated based on the evaluation.

2. The method of claim 1, wherein the method further comprises:
based on the evaluation, performing one or more of:
(i) labeling said at least one HR filter for generating audio;
(ii) selecting a different set of HR filters for generating audio; or
(ii) not using said at least one HR filter for generating audio;
generating updated HR filter data indicating an updated set of HR filters, wherein the updated set of HR filters (i) includes the labeled at least one HR filter, (ii) excludes the labeled at least one HR filter, (iii) is the different set of HR filters, or (iv) excludes said at least one HR filter; and
storing and/or transmitting updated HR filter data and/or generating audio using the updated HR filter data.

3. (canceled)

4. The method of claim 1, wherein
the method further comprises using the obtained HR filter data, calculating a first set of feature values and/or a second set of feature values,
a feature value included in the first set and/or a feature value included in the second set indicates where a portion of impulse response of said at least one HR filter is located in a temporal domain, and
the feature value included in the first set and/or the feature value included in the second set is a normalized measure of dispersion of the impulse responses of the HR filters included in the set of HR filters and/or a normalized measure of dispersion of the impulse response of the HR filters.

5-6. (canceled)

7. The method of claim 4, wherein
each feature value included in the first set is SIOD[n], where n is an index of an HR filter tap at a time instant, and
$$SIOD [ n ] = \frac{\frac{1}{{M}^{′}} {\sum }_{m = 1}^{{M}^{′}} {\vert h [ n ; m ] - \frac{1}{{M}^{′}} {\sum }_{m = 1}^{{M}^{′}} h [ n ; m ] \vert}^{2}}{\frac{1}{{M}^{′}} {\sum }_{m = 1}^{{M}^{′}} \vert h [ n ; m ] \vert} ,$$
where
M′ is a number of HR filters included in the set or ½ of the number of HR filters included in the set of HR filters,
m is a filter index of an HR filter included in the set of HR filters, and
h[n; m] is a value of an HR filter having an index value of m at an HR filter tap n.

8. The method of claim 4, wherein
each feature value included in the second set is TIOD[n;m], where n is an index of an HR filter tap at a time instant, and
$$TIOD [ n ; m ] = \frac{{\vert h [ n ; m ] - \frac{1}{N} {\sum }_{n = 1}^{N} h [ n ; m ] \vert}^{2}}{\frac{1}{N} {\sum }_{n = 1}^{N} \vert h [ n ; m ] \vert} ,$$
where
N is length of an HR filter included in the set of HR filters,
m is a filter index of an HR filter included in the set of HR filters, and
h[n; m] is a value of an HR filter having an index value of m at an HR filter tap n.

9. The method of claim 4, wherein determining the time interval comprises:
calculating an initial start time of the time interval using the feature values included in the first set, and/or
calculating an initial end time of the time interval using the feature values included in the second set.

10. The method of claim 9, wherein
the initial start time of the time interval is calculated based on (i) a normalized cumulative sum of the feature values included in the first set and (ii) a threshold value for determining the initial start time, and.
$${n}_{s 0} = {arg min}_{n} ( \text{?} [ n ] > {η}_{s 0} ) ,$$
where
nₛ₀ is the initial start time of the time interval,
n is a positive integer, [symbol]
[n] is the normalized cumulative sum of the feature values included in the first set, and
ηₛ₀ is the threshold value for determining the initial start time.

11. (canceled)

12. The method of claim 9, wherein
the second set of feature values (e.g., a set containing TIOD curve #1, TIOD curve #2, . . . , etc.) comprises a plurality of subsets of feature values,
each feature value included in each subset of feature values is identified by an index value,
in each subset of feature values, the highest feature value among the feature values is identified by a peak index value, and
the initial end time of the time interval is calculated based on frequency densities of the peak index values of the plurality of subsets.

13. The method of claim 12, wherein the initial end point nₑ₀ is evaluated as
$${n}_{e 0} = 𝔑 [ {arg max}_{i} ( Pr [ i ] > {η}_{e 0} ) ] ,$$
where
Pr[i] is a frequency density of a peak index value i,
the frequency density of the peak index value i indicates how many times the peak index value i identifies the highest feature value among feature values included in each subset of feature values for the plurality of subsets,
i is an integer greater than 0,
1≤i≤I,
I is a number of the peak index values included in [symbol] , [symbol]
is a set of the peak index values,
ηₑ₀ is a threshold value for determining the initial end time, and
$$𝔑 [ {arg max}_{i} ( Pr [ i ] > {η}_{e 0} ) ]$$
is a peak index value included in [symbol] , which corresponds to an index of
$${arg max}_{i} ( Pr [ i ] > {η}_{e 0} ) .$$

14. The method of claim 12, wherein determining the time interval comprises:
obtaining a group ( [symbol] ) of peak index values; and
calculating an adjusted start time of the time interval based on the initial start time of the time interval and the group of peak index values.

15. The method of claim 14, wherein each peak index value included in the group of the peak index values satisfies the following conditions:
(i) the peak index value corresponds to a location which is before the initial end time of the time interval,
(ii) a difference between the peak index value and a next peak index value within a set of peak index values arranged in ascending order is greater than a threshold value, and
(iii) a frequency density of the peak index value is lower than a threshold density value.

16. The method of claim 14, wherein the adjusted start time nₛ is calculated as
nₛ=max(nₛ₀,min( [symbol] >max( [symbol] ))), where
nₛ₀ is the initial start time, [symbol]
is the set of peak index values, and [symbol]
is the group of peak index values.

17. The method of claim 13, wherein determining the time interval comprises:
obtaining a group ( [symbol] ) of peak index values; and
calculating an adjusted end time of the time interval based on the initial end time of the time interval and the group of peak index values,
each peak index value included in the group satisfies one or more of the following conditions:
the peak index value indicates a location which is after the initial end time of the time interval,
a difference between the peak index value and a next peak index value within a set of peak index values arranged in ascending order is greater than a threshold value, and
a frequency density of the peak index value is lower than a threshold density value, and the adjusted end time nₑ is calculated as
nₑ=max(nₑ₀,max( [symbol] ≤min( [symbol] ))), where
nₑ₀ is the initial end time, [symbol]
is the set of peak index values, and [symbol]
is the group of peak index values.

18-19. (canceled)

20. The method of claim 1, wherein evaluating at least one HR filter included in the set using the determined time interval comprises:
calculating a first amount of energy of said at least one HR filter within the time interval; and
calculating a total amount of energy of said at least one HR filter.

21. The method of claim 20, wherein evaluating at least one HR filter included in the set using the determined time interval comprises:
determining a ratio of the first amount of energy and the total amount of energy; and
labeling said at least one HR filter using the determined ratio.

22. The method of claim 21, wherein evaluating at least one HR filter included in the set using the determined time interval comprises:
comparing the determined ratio to a threshold value; and
as a result of determining that the determined ratio is less than the threshold value, labeling said at least one HR filter.

23. The method of claim 22, wherein
the at least one HR filter is associated with a particular angle, and
the threshold value is determined based on the particular angle.

24. The method of claim 22, wherein
evaluating at least one HR filter included in the set using the determined time interval comprises evaluating an m-th HR filter, h[m], associated with an index value m,
$$γ [ m ] = \frac{{\sum }_{n = {n}_{s}}^{{n}_{e}} {( h [ n , m ] - \frac{1}{N} {\sum }_{n = 1}^{N} h [ n , m ] )}^{2}}{{\sum }_{n = 1}^{N} {( h [ n , m ] - \frac{1}{N} {\sum }_{n = 1}^{N} h [ n , m ] )}^{2}} ,$$
where γ is the ratio, h[n, m] is an impulse response of the m-th HR filter at an HR filter tap n, nₛ is a starting time of the time interval, and nₑ is an ending time of the time interval, and
each of n and m is a positive integer.

25. The method of claim 22, wherein
evaluating at least one HR filter included in the set using the determined time interval comprises evaluating an m-th HR filter, h[m], associated with an index value m,
$$γ [ m ] = \frac{{\sum }_{n = {𝔫}_{s}}^{{𝔫}_{e}} {( h [ n , m ] )}^{2}}{{\sum }_{n = 1}^{N} {( h [ n , m ] )}^{2}} ,$$
where γ is the ratio, h[n, m] is an impulse response of the m-th HR filter at an HR filter tap n, nₛ is a starting time of the time interval, and nₑ is an ending time of the time interval, and
each of n and m is a positive integer.

26-29. (canceled)

30. An apparatus comprising:
a memory; and
processing circuitry coupled to the memory, wherein the apparatus is configured to perform a method comprising:
obtaining head-related, HR, filter data indicating a set of HR filters for generating audio corresponding to temporal and/or spectral changes of sound waves;
determining a time interval for evaluating HR filters included in the set; and
evaluating at least one HR filter included in the set using the determined time interval, wherein
audio is generated based on the evaluation.
